(19) United States
(12) Patent Application Publication
(10) Pub. No.: US 2018/0072624 A1
(43) Pub. Date: Mar. 15, 2018

(54) MICROCAPSULE FOR SELF-HEALING CONCRETE AND PREPARATION METHOD THEREOF, AND SELF-HEALING CONCRETE AND PREPARATION METHOD THEREOF

(71) Applicant: SHENZHEN UNIVERSITY, Shenzhen (CN)

(72) Inventor: Biqin DONG, Shenzhen (CN)

(73) Assignee: SHENZHEN UNIVERSITY, Shenzhen (CN)

(21) Appl. No.: 15/562,111

(22) PCT Filed: Mar. 30, 2016
(86) PCT No.: PCT/CN2016/077788

§ 371 Date: Sep. 27, 2017

(30) Foreign Application Priority Data
Mar. 31, 2015 (CN) 201510148725.X

(51) Int. Cl. C04B 24/38; C04B 22/14; C04B 24/26; C04B 28/02; C04B 14/06; B01J 13/04

(52) U.S. Cl. CPC C04B 24/383; C04B 22/148; C04B 24/2676; C04B 2111/2038; C04B 14/06; B01J 13/043; C04B 28/02

(57) ABSTRACT

Disclosed are a microcapsule for self-healing concrete and a preparation method thereof, and a self-healing concrete and a preparation method thereof. The microcapsule comprises a core and a wall, the components of the core comprising a healing agent, microcrystalline cellulose and Tween 80, and a material of the wall being a high-molecular organic material sensitive to stress of cracks. The preparation method for the self-healing concrete comprises steps of: weighing appropriate amounts of cement, sand, water and the above microcapsules, with each cubic meter of concrete containing 0.05 to 0.08 cubic meter of the microcapsules; stirring the cement, sand and microcapsules until uniformly dispersed to obtain a mixture; and pouring the water into the mixture, and stirring uniformly.

The present application claims priority to Chinese application number 201510148725.X, filed 31 Mar. 2015, with a title of MICROCAPSULE FOR SELF-HEALING CONCRETE AND METHOD FOR PREPARING THE SELF-HEALING CONCRETE. The above-mentioned patent application is incorporated herein by reference in its entirety.

### TECHNICAL FIELD

The present invention relates to the field of concrete cracks self-healing, and in particular to a microcapsule for self-healing concrete and preparation method thereof, and a self-healing concrete and preparation method thereof.

### BACKGROUND

Concrete is now the most widely used building material and structural material. Because of its structural composition and load-bearing capacity, the concrete often has some internal original micro-cracks, and during its service, with the change of the load and the passage of time, the internal micro-cracks will expand into large cracks, and even extend to the surface of the concrete to cause cracking of the concrete material. After formation of through cracks, the concrete is vulnerable to external environment and a variety of harmful factors such as steel corrosion, carbonation, chloride ion erosion and sulfate erosion, ultimately leading to cracking and destruction of the concrete, and thus not meeting the use requirements and seriously affecting the durability of the concrete material.

The control and healing of the cracks is the key to improve the durability of the concrete material. At present, there are several common methods for healing the cracks, i.e., organic coating healing method, grouting method, and fiber covering healing method.

Chinese Patent No. CN200810158131.7 discloses a formula of a concrete cracks self-healing material and a preparation process thereof, the formula comprising, in percentages by weight, 62% to 77% Portland cement, 0.2% to 1.0% sodium citrate, 3.0% to 8.0% choline, 1% to 4% sodium silicate, 1.0% to 3.0% calcium oxide, and 22% to 35% quartz sand in a range from 80 mesh to 120 mesh, and the preparation process comprising steps of mixing 62% to 77% by weight of Portland cement and 22% to 35% by weight of quartz sand in a range from 80 mesh to 120 mesh in a mixer; during the mixing, adding 0.2% to 1.0% by weight of sodium citrate, 3.0% to 8.0% by weight of choline, 1% to 4% by weight of sodium silicate, and 1.0% to 3.0% by weight of calcium oxide; and discharging the product and sealing it for storage after a mixing time of 3 to 5 minutes.

However, the above methods for concrete cracks self-healing are very limited. For example, the intelligence is poor, and it is impossible to track the development of the cracks and provide timely healing. This makes concrete cracks healing effect, control of the cracks, and long-term monitoring have great drawbacks.

### SUMMARY

To overcome the drawbacks in the prior art, the present invention provides a microcapsule sensitive to stress of cracks from the outside and having a physical trigger capability and a preparation method thereof. The microcapsules provided by the present invention can be implanted into a concrete to form a microcapsule—concrete self-healing system which achieves self-healing ability of cracks in the concrete and has a feature of intelligent control.

Another technical problem solved by the present invention is to provide a self-healing concrete having an intelligent control ability, and a preparation method thereof.

To solve the above-mentioned problems, the present invention provides a microcapsule for self-healing concrete, including a core and a wall, components of the core comprising a healing agent, microcrystalline cellulose and Tween 80, and a material of the wall being a high-molecular organic material sensitive to stress of cracks.

Preferably, the core is prepared by the following steps:

201. weighing raw materials for producing the core according to the following parts by weight:

| | |
|---|---|
| healing agent | 100; |
| microcrystalline cellulose | 90 to 100; |
| Tween 80 | 8 to 10; |
| 30% ethanol | 100 to 120; |

wherein, said 30% ethanol is an ethanol solution having an ethanol concentration of 30% by volume;

202. extruding a mixture: mixing the raw materials in said step 201 and feeding them into an extrusion device to obtain a rice noodle shaped core material;

203. spheronizing the core material: pouring the rice noodle shaped core material into a roll of a spheronizing device to obtain core particles; and

204. drying: drying the core particles under a forced ventilation condition, with a drying temperature of 30 to 40° C.

Preferably, the microcapsule is prepared by the following steps:

301. preparing a coating liquid: weighing 100 parts by weight of the high-molecular organic material sensitive to stress of cracks and 900 to 1600 parts by weight of a solvent, and dissolving the high-molecular organic material in the solvent to obtain the coating liquid;

302. spraying the coating liquid: placing the cores into a roll of a spray coating device, spraying the coating liquid obtained in said step 301 onto the rolling cores by a spray nozzle of this device using a pump in a coating mode; and adding 1 to 2 g talcum powder every 5 to 10 minutes to obtain cores with coating; and

303. drying: drying the cores with coating obtained in said step 302 under a forced ventilation condition, and then performing a temperature decreasing naturally and drying naturally process to obtain the microcapsules, with a drying temperature of 30 to 40° C., a drying time of 10 to 20 minutes, and the drying process carried out in a roll of a drying device.

Preferably, the solvent is a mixture of ethanol and toluene, or trichlorotoluene.

Preferably, a weight ratio of ethanol to toluene in the mixture of ethanol and toluene is (150 to 300):(800 to 1000).

Preferably, the high-molecular organic material sensitive to stress of cracks is polyacrylic acid resin, polystyrene or ethyl cellulose.

Preferably, in said step 301, 100 parts by weight of ethyl cellulose, 150 to 300 parts by weight of ethanol, and 800 to 1000 parts by weight of toluene are used to prepare the coating liquid, and the ethyl cellulose is dissolved in the mixture of ethanol and toluene.

Preferably, in said step 301, 100 parts by weight of polystyrene, and 900 to 1600 parts by weight of trichloromethane are used to prepare the coating liquid, and the polystyrene is dissolved in the trichloromethane.

Preferably, the microcapsule is spherical and has a particle size of 200 to 500 μm, and a thickness of the wall is 50 to 200 μm.

Preferably, the healing agent is sulphoaluminate cement.

Preferably, the components of the core further include a curing healing material.

Preferably, the curing healing material is an epoxy resin or a curing agent.

The present invention also provides a method for preparing the microcapsule for self-healing concrete, including steps of:

1301. preparing cores: mixing the healing agent, microcrystalline cellulose, Tween 80 and 30% ethanol and feeding the mixture into an extrusion device through a feeding port thereof to obtain a rice noodle shaped core material by extrusion; pouring the rice noodle shaped core material into a roll of a spheronizing device to obtain core particles; and feeding the core particles into a roll of a drying device and performing a drying process under a forced ventilation condition with a drying temperature of 30 to 40° C.;

1302. preparing a coating liquid: weighing 100 parts by weight of the high-molecular organic material sensitive to stress of cracks and 900 to 1600 parts by weight of a solvent, and dissolving the high-molecular organic material in the solvent to obtain the coating liquid;

1303. spraying the coating liquid: placing the cores obtained in said step 1301 into a roll of a spray coating device, spraying the coating liquid obtained in said step 1302 onto the rolling cores by a spray nozzle of this device using a pump in a coating mode; and adding 1 to 2 g talcum powder every 5 to 10 minutes to obtain cores with coating; and

1304. drying: drying the cores with coating obtained in said step 1303 under a forced ventilation condition, and then performing a temperature decreasing naturally and drying naturally process to obtain the microcapsules, with a drying temperature of 30 to 40° C., a drying time of 10 to 20 minutes, and the drying process carried out in a roll of a drying device.

The present invention further provides a self-healing concrete, including cement, sand, water, and the microcapsules according to the above technical scheme or prepared according to the above-mentioned method, with each cubic meter of the concrete containing 0.05 to 0.08 cubic meter of the microcapsules.

The present invention also provides a method for preparing the self-healing concrete, including steps of:

1501. weighing appropriate amounts of cement, sand, water and the microcapsules according to the above technical scheme or prepared according to the above-mentioned method, with each cubic meter of concrete containing 0.05 to 0.08 cubic meter of the microcapsules;

1502. stirring the cement, sand and microcapsules weighed in said step 1501 until uniformly dispersed to obtain a mixture; and

1503. pouring the water into the mixture obtained in said step 1502, stirring them to be uniform to obtain the self-healing concrete.

The present invention provides a microcapsule for self-healing concrete, including a core and a wall, characterized in that components of the core include a healing agent, microcrystalline cellulose and Tween 80, and the wall is made of a high-molecular organic material which is sensitive to stress of cracks. In the present invention, for the microcapsule for self-healing concrete, the material of the wall is a high-molecular organic material which is sensitive to stress of cracks, and can burst to release the core material when cracks appear during use of the concrete. The healing agent in the core material can react, inside the concrete, to form an expansion product to fill the cracks, thereby achieving the healing of the cracks. In addition, a curing healing material having capability for filling and healing the cracks may be used as one of the materials forming the core, thereby achieving the healing of the cracks.

The microcapsule preparation process used in the invention is simple and easy to be realized, and provides conditions for industrialized batch production.

The self-healing concrete based on the microcapsule according to the present invention is to dope the traditional concrete components with microcapsules sensitive to stress from the outside and having a physical trigger capability, and a self-healing system which can heal the cracks intelligently is formed inside the concrete. By means of the typical production process for the concrete, the microcapsules are evenly distributed in the concrete. During the mixing and curing process, the microcapsule material does not break. When the internal environment of the concrete is stable, that is, when no cracks generate, the microcapsules implanted in the concrete can exist in the matrix stably for a long period. During use of the concrete, once cracks produce stress, the microcapsules are triggered to crack and then release the healing agent to fill the cracks, thereby achieving the purpose of healing the cracks.

### BRIEF DESCRIPTION OF THE DRAWING

FIG. 1 is a scanning electron micrograph of microcapsules according to an embodiment of the present invention;

FIG. 2 is a distribution diagram of the microcapsules in a cement-based material sample according to an embodiment of the present invention (XCT horizontal section);

FIG. 3 is a scanning electron micrograph of the microcapsule according to an embodiment of the present invention under physical stress triggering;

FIG. 4 is a 3D reconstruction diagram of the microcapsules in the cement-based material sample according to an embodiment of the present invention;

FIG. 5-1 is an image of the XCT horizontal section of a cement-based material sample in Example 1 of the present invention after the microcapsules healing the cracks for 0 day;

FIG. 5-2 is an image of the XCT horizontal section of the cement-based material sample in Example 1 of the present invention after the microcapsules healing the cracks for 63 days;

FIG. 5-3 is an image of the XCT horizontal section of the cement-based material sample in Example 1 of the present invention after the microcapsules healing the cracks for 105 days;

FIG. 6-1 is an image of the XCT horizontal section of a cement-based material sample in Example 2 of the present invention after the microcapsules healing the cracks for 0 day;

FIG. 6-2 is an image of the XCT horizontal section of the cement-based material sample in Example 2 of the present invention after the microcapsules healing the cracks for 63 days;

FIG. 6-3 is an image of the XCT horizontal section of the cement-based material sample in Example 2 of the present invention after the microcapsules healing the cracks for 105 days;

FIG. 7 shows rates of the volume of the cracks in the cement-based material samples in Examples 1 and 2 in the present invention occupying the total volume of the respective samples in different healing ages; and

FIG. 8 shows healing rates of the cracks in the cement-based material samples in Examples 1 and 2 in the present invention by the respective microcapsules therein in different healing ages.

### DETAILED DESCRIPTION

The present invention will now be further described with reference to embodiments and the drawings.

The present invention provides a microcapsule for self-healing concrete, including a core and a wall, characterized in that components of the core include a healing agent, microcrystalline cellulose and Tween 80, and the wall is made of a high-molecular organic material sensitive to stress of cracks.

In the present invention, for the microcapsule for the self-healing concrete, the material of the wall is a high-molecular organic material sensitive to stress of cracks, and can burst to release the core material when cracks appear during use of the concrete. The healing agent in the core material can react, inside the concrete, to form an expansion product to fill the cracks, thereby achieving the healing of the cracks. In addition, a curing healing material having capability for filling and healing the cracks may be used as one of the materials forming the core, thereby achieving the healing of the cracks.

The microcapsule for the self-healing concrete provided by the present invention includes a core. For its components, the core includes a healing agent, microcrystalline cellulose and Tween 80. In the present invention, the healing agent is preferably sulphoaluminate cement. According to the present invention, no special requirements have to be met by the sulphoaluminate cement, and any sulpholuminate cement well known to those skilled in the art may be used. Also, no special requirements have to be met by Tween 80, and any Tween 80 well known to those skilled in the art may be used. In the present invention, a mass ratio of the healing agent, microcrystalline cellulose and Tween 80 is preferably 100:(90 to 100):(8 to 10), more preferably 100:95:9.

In the present invention, preferably, the core may further include a curing healing material. In the present invention, the curing healing material is preferably an epoxy resin or a curing agent. The source of the epoxy resin or the curing agent is not particularly limited in the present invention, and any epoxy resin or curing agent well known to those skilled in the art can be used. In the present invention, a mass ratio of the curing healing material, microcrystalline cellulose and Tween 80 is preferably 100:(90 to 100):(8 to 10), more preferably 100:95:9.

In the present invention, the particle size of the core is preferably 150 to 500 μm, more preferably 200 to 400 μm.

The microcapsule for the self-healing concrete provided by the present invention includes a wall, the material of which is a high-molecular organic material which is sensitive to stress of cracks. In the present invention, the high-molecular organic material sensitive to stress of cracks is preferably polyacrylic acid resin, polystyrene resin or ethyl cellulose.

In the present invention, the thickness of the wall is preferably 50 to 200 μm, more preferably 50 to 100 μm.

The microcapsule provided by the present invention preferably has a spherical shape, and the particle size of the microcapsule is preferably 150 to 500 μm.

In the present invention, the cores are preferably prepared by the following steps:

201. Weighing raw materials for producing the cores according to the following parts by weight:

| | |
|---|---|
| healing agent | 100; |
| microcrystalline cellulose | 90 to 100; |
| Tween 80 | 8 to 10; |
| 30% ethanol | 100 to 120; |

Where, said 30% ethanol is an ethanol solution having an ethanol concentration of 30% by volume;

205. Extruding a mixture: mixing the raw materials in said step 201 and feeding them into an extrusion device to obtain a rice noodle shaped core material;

206. Spheronizing the core material: pouring the rice noodle shaped core material into a roll of a spheronizing device to obtain core particles; and

207. Drying: drying the core particles under a forced ventilation condition, with a drying temperature of 30° C. to 40° C.

In the present invention, the raw materials for producing the cores preferably include, in parts by weight, 100 parts of healing agent, 90 to 100 parts of microcrystalline cellulose, 8 to 10 parts of Tween 80 and 100 to 120 parts of ethanol. In one embodiment, specifically, the raw materials include, in parts by weight, 100 parts of healing agent, 95 parts of microcrystalline cellulose, 9 parts of Tween 80 and 110 parts of ethanol; or, 100 parts of healing agent, 95 parts of microcrystalline cellulose, 10 parts of Tween 80 and 115 parts of ethanol.

For the preparation of the cores, the ethanol is preferably an ethanol solution having an ethanol concentration of 30% by volume.

According to the present invention, after the raw materials are weighed, preferably, the raw materials are mixed and fed into an extrusion device through a feeding port of the extrusion device, and extruded to obtain a rice noodle shaped core material. According to the present invention, no special requirements have to be met by the extrusion device, and any extrusion device well known to those skilled in the art may be used. Parameters related to the extruding process are not particularly defined, and any parameters related to the extruding process well known to those skilled in the art may be used.

According to the present invention, after the rice noodle shaped core material is obtained, preferably, the core material is poured into a roll of a spheronizing device and then spheronized to obtain core particles. Any spheronizing device well known to those skilled in the part may be used.

According to the present invention, after the core particles are obtained, preferably, the core particles rolling out of the spheronizing device are fed into a roll of a drying device and dried under a forced ventilation condition. In the present invention, the drying temperature is preferably 30° C. to 40° C. After the drying process, the cores are finally obtained.

The present invention also provides a method for preparing microcapsules for self-healing concrete, including steps of:

1301. Preparing cores: mixing a healing agent, microcrystalline cellulose, Tween 80 and 30% ethanol and feeding the mixture into an extrusion device through a feeding port thereof to obtain a rice noodle shaped core material by extrusion; pouring the rice noodle shaped core material into a roll of a spheronizing device to obtain core particles; and feeding the core particles into a roll of a drying device and performing a drying process under a forced ventilation condition with a drying temperature of 30° C. to 40° C.;

1302. Preparing a coating liquid: weighing 100 parts by weight of a high-molecular organic material which is sensitive to stress of cracks and 900 to 1600 parts by weight of a solvent, and dissolving the high-molecular organic material in the solvent to obtain the coating liquid;

1303. Spraying the coating liquid: placing the cores obtained in said step 1301 into a roll of a spray coating device, spraying the coating liquid obtained in said step 1302 onto the rolling cores by a spray nozzle of this device using a pump in a coating mode; and adding 1 to 2 g talcum powder every 5 to 10 minutes to obtain cores with coating; and

1304. Drying: drying the cores with coating obtained in said step 1303 under a forced ventilation condition, and then performing a temperature decreasing naturally and drying naturally process to obtain the microcapsules, with a drying temperature of 30° C. to 40° C., a drying time of 10 to 20 minutes, and the drying process carried out in a roll of a drying device.

According to the present invention, the cores are preferably prepared according to the above-mentioned method for preparing the cores, which is not repeatedly described herein.

According to the present invention, after the cores are obtained, a coating liquid is preferably prepared. In the present invention, preferably, 100 parts by weight of a high-molecular organic material which is sensitive to stress of cracks and 900 to 1600 parts by weight of a solvent are weighed, and the high-molecular organic material is then dissolved in the solvent to obtain the coating liquid. In the present invention, the solvent is preferably a mixture of ethanol and toluene, or trichlorotoluene.

In the present invention, when the mixture of ethanol and toluene is used as the solvent, it is preferable that a weight ratio of ethanol to toluene is preferably (150 to 300):(800 to 1000). The source of ethanol or toluene is not particularly defined in the present invention, and any ethanol or toluene well known to those skilled in the art may be used. When ethyl cellulose is used as the high-molecular organic material sensitive to stress of cracks, 100 parts by weight of ethyl cellulose, 150 to 300 parts by weight of ethanol, and 800 to 1000 parts by weight of toluene are preferably used as the raw materials for preparing the coating liquid. According to the present invention, it is preferable that the ethyl cellulose is dissolved in the mixture of ethanol and toluene.

In the present invention, when trichlorotoluene is used as the solvent, any trichlorotoluene well known to those skilled in the art may be used. When polystyrene is used as the high-molecular organic material sensitive to stress of cracks, 100 parts by weight of polystyrene, and 900 to 1600 parts by weight of trichloromethane are preferably used as the raw materials for preparing the coating liquid. In the embodiments of the present invention, the trichloromethane may be specifically used in an amount of 900 parts by weight, 1000 parts by weight, 1200 parts by weight, 1400 parts by weight or 1600 parts by weight. It is preferable that the polystyrene is dissolved in the trichloromethane.

According to the present invention, after the coating liquid is obtained, the cores are preferably placed into a roll of a spray coating device. The coating liquid is then sprayed onto the rolling cores via a spray nozzle of this device using a pump under a coating mode. 1 to 2 g talcum powder is added every 5 to 10 minutes. The cores with coating are finally obtained.

According to the present invention, after the cores with coating are obtained, they are preferably cooled naturally and dried naturally after being dried under a forced ventilation condition to obtain the microcapsules. In the present invention, a drying temperature is preferably 30° C. to 40° C., and a drying time is preferably 10 to 20 minutes. The drying process is preferably performed in a roll of a drying device. No special requirements have to be met by the drying device, and any drying device well known to those skilled in the art may be used.

According to the present invention, after the microcapsules are obtained, it is preferable that physical properties of the obtained microcapsules are analyzed to determine whether the obtained microcapsules meet the requirements of the concrete self-healing system. In the embodiments of the present invention, specifically, an electron microscope scanning apparatus is used for photographic analysis. Preferably, the obtained microcapsules are also subjected to a stress performance test to determine whether the obtained microcapsules are able to crack under stress.

The present invention provides a self-healing concrete, including cement, sand, water, and the microcapsules according to the above-mentioned technical scheme or prepared according to the above-mentioned method. Each cubic meter of the concrete contains 0.05 to 0.08 cubic meter of the microcapsules.

The present invention further provides a method for preparing the self-healing concrete, including steps of:

1501. weighing appropriate amounts of cement, sand, water and the microcapsules according to the above-mentioned technical scheme or prepared according to the above-mentioned method, with each cubic meter of concrete containing 0.05 to 0.08 cubic meter of the microcapsules;

1502. Stirring the cement, sand and microcapsules weighed in said step 1501 until they are uniformly dispersed to obtain a mixture; and

1503. Pouring the water into the mixture obtained in said step 1502, stirring them to be uniform to obtain the self-healing concrete.

In the present invention, a mass ratio of the cement to the water is preferably 1:0.4.

In the present invention, it is preferable to perform a performance test on the obtained concrete. The obtained concrete is preferably cured to obtain a concrete curing sample. In the present invention, no special requirements have to be met by the curing process of the concrete, and any curing method well known to those skilled in the art may be used. In the embodiments of the present invention, the curing method includes steps of vibrating the concrete, casting workpiece, standing, stripping, striking off slurry of the mold, secondary standing, removing the mold and curing. In the present invention, the process of casting workpiece is preferably a stepwise or step-by-step method. The time for standing is preferably 1 to 2 hours, and the time for secondary standing is preferably 24 hours. The curing process is preferably carried out in a standard curing chamber for concrete, and the curing time is preferably 28 days. No special requirements have to be met by the standard curing chamber for concrete, and any standard curing chamber for concrete well known to those skilled in the art may be used.

After the concrete curing sample is obtained, it is preferable to preload the concrete curing sample with a load of 900 N to obtain a concrete curing sample with internal cracks. In the present invention, it is preferable to perform an X-ray computed tomography scanning technique (XCT) on the concrete curing sample with internal cracks for observation and analysis. In the present invention, after the XCT analysis is completed, it is preferable to perform a secondary curing on the concrete curing sample with internal cracks. The condition of the secondary curing is preferably a standard curing condition. Specifically, the relative humidity is higher than 95%, and the temperature is 21° C. In the embodiments of the present invention, the time for the secondary curing is specifically 0 day, 21 days, 42 days, 63 days, 84 days or 105 days. It is preferable to perform XCT analysis, 3D reconstruction and image processing analysis on the secondary cured concrete curing sample to observe the modification of the cracks in the self-healing concrete.

The present invention provides a microcapsule for self-healing concrete, including a core and a wall, characterized in that components of the core include a healing agent, microcrystalline cellulose and Tween 80, and the wall is made of a high-molecular organic material which is sensitive to stress of cracks. In the present invention, for the microcapsule for self-healing concrete, the material of the wall is a high-molecular organic material which is sensitive to stress of cracks, and can burst to release the core material when cracks appear during use of the concrete. The healing agent in the core material can react, inside the concrete, to form an expansion product to fill the cracks, thereby achieving the healing of the cracks. In addition, a curing healing material having capability for filling and healing the cracks may be used as one of the materials forming the core, thereby achieving the healing of the cracks.

The microcapsule preparation process used in the invention is simple and easy to be realized, and provides conditions for industrialized batch production.

The self-healing concrete based on the microcapsule according to the present invention is to dope the traditional concrete components with microcapsules sensitive to stress from the outside and having a physical trigger capability, and a self-healing system which can heal the cracks intelligently is formed inside the concrete. By means of the typical production process for the concrete, the microcapsules are evenly distributed in the concrete. During the mixing and curing process, the microcapsule material does not break. When the internal environment of the concrete is stable, that is, when no cracks generate, the microcapsules implanted in the concrete can exist in the matrix stably for a long period. During use of the concrete, once cracks produce stress, the microcapsules are triggered to crack and then release the healing agent to fill the cracks, thereby achieving the purpose of healing the cracks.

The microcapsule for self-healing concrete and preparation method thereof, and self-healing concrete and preparation method thereof provided by the present invention will now be described below with reference to examples, which should not be construed as limiting the scope of the present invention.

### Example 1

Preparation of Ethyl Cellulose Encapsulated Sulphoaluminate Self-Healing Concrete

(1) Preparation of the Cores

TABLE 1
Amounts of raw materials for producing the cores
with sulphoaluminate cement as the healing agent (parts by weight)

| | Sulphoaluminate | Microcrystalline | | |
|---|---|---|---|---|
| No. | Cement | Cellulose | Tween 80 | 30% Ethanol |
| I | 100 | 90 | 8 | 100 |
| II | 100 | 90 | 10 | 110 |
| III | 100 | 95 | 9 | 110 |
| IV | 100 | 95 | 10 | 115 |
| V | 100 | 100 | 10 | 120 |

Wherein, 30% ethanol was an ethanol solution having an ethanol concentration of 30% by volume.

Raw materials for producing the cores were weighed according to the five formulas in Table 1, and then mixed. The mixture was fed into an extrusion device for extrusion, and a rice noodle shaped core material was then extruded. The rice noodle shaped core material was poured into a roll of a spheronizing device, and core particles were rolled out of the device. The core particles were dried at 30° C. to 40° C. under a force ventilation condition to obtain the cores.

(2) Preparation of the Microcapsules

TABLE 2
Amounts of raw materials for preparing the coating liquid
with a mixture of ethanol and toluene as the solvent

| No. | Ethyl Cellulose | Ethanol | Toluene |
|---|---|---|---|
| I | 100 | 150 | 850 |
| II | 100 | 200 | 800 |
| III | 100 | 200 | 1000 |
| IV | 100 | 300 | 900 |
| V | 100 | 240 | 960 |

a. The raw materials were weighed according to the five formulas in Table 2, and the ethyl cellulose was dissolved in the mixture of ethanol and toluene to prepare the coating liquid.

b. The coating liquid was atomized and then sprayed onto the cores obtained in said step (1). 1 to 2 g talcum powder was added every 5 to 10 minutes. These cores were dried at 30 to 40° C. for 10 to 20 minutes under a forced ventilation condition, then cooled naturally and dried naturally to obtain the microcapsules.

The produced microcapsules are spherical, and have a particle size of 200 to 500 μm and a wall thickness of 50 to 100 μm.

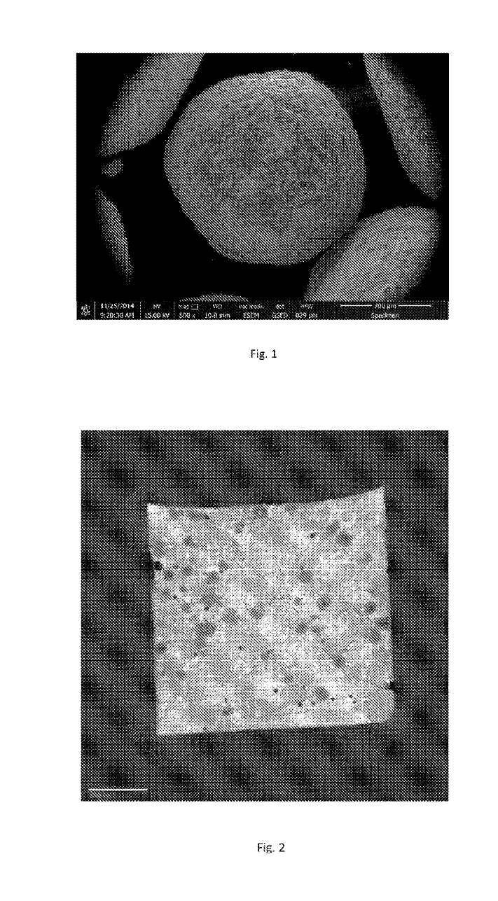

The produced microcapsules were placed under an electron microscope scanning apparatus for photographic analysis (as shown in FIG. 1) to observe whether the produced microcapsules met the requirements of the self-healing systems. According to FIG. 1, it can be seen that the produced microcapsules according to the present invention had good physical properties. Specifically, the produced microcapsules had a rough surface, an uniform particle size distribution, and a good shaping degree. These can cause better integral formation of the microcapsules and the concrete and an uniform distribution of the microcapsules.

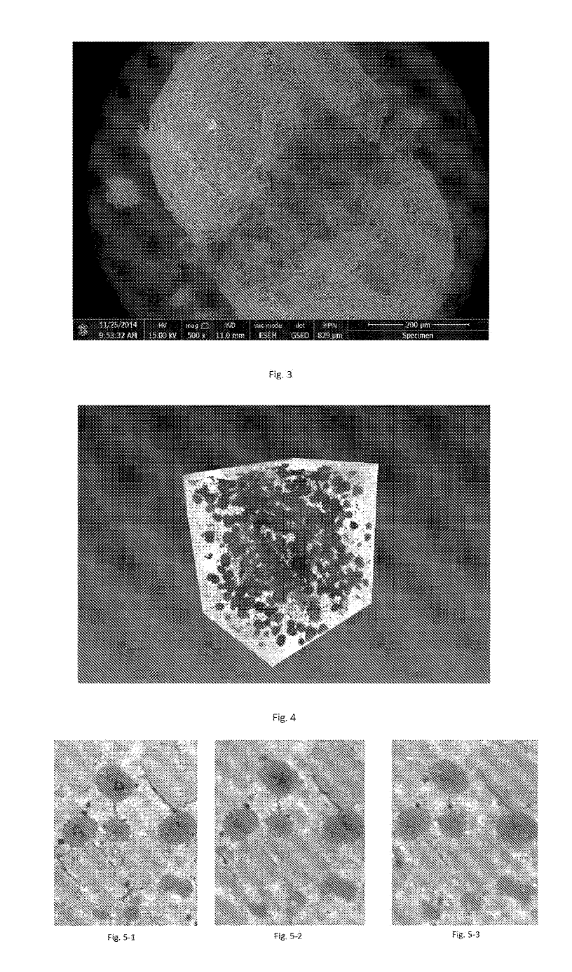

The produced microcapsules were placed on a physical stress triggering device to study whether the produced microcapsules according to the present invention were able to crack under stress. As shown in FIG. 3, it can be seen that the microcapsules were able to be triggered to crack under stress.

(3) Preparation of Ethyl Cellulose-Sulphoaluminate Self-Healing Concrete and Performance Testing Thereof

A. 1 kg cement, 1 kg sand, 0.4 g water, and 50 g microcapsules prepared in said step (2) were weighed;

B. The cement, sand and microcapsules weighed in said step A were added into a cement agitator and then stirred until they were uniformly dispersed to obtain a mixture;

C. The weighed water was poured into the mixture obtained in said step B, and then stirred uniformly;

D. The stirring process was performed slowly first and then faster;

E. After the concrete was vibrated, a workpiece was cast stepwise or step by step;

F. After a standing time of 1 to 2 hour, the mold was stripped, the overflow concrete slurry of the mold was struck off, and a secondary standing was performed for 24 hours;

G. The mold was removed, and the sample was placed into a standard curing chamber for concrete for curing for 28 days;

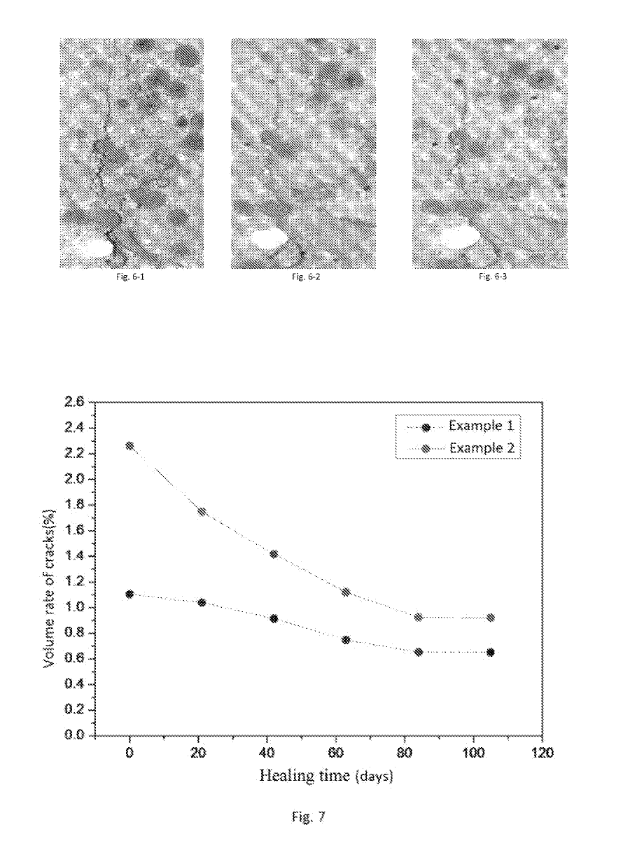

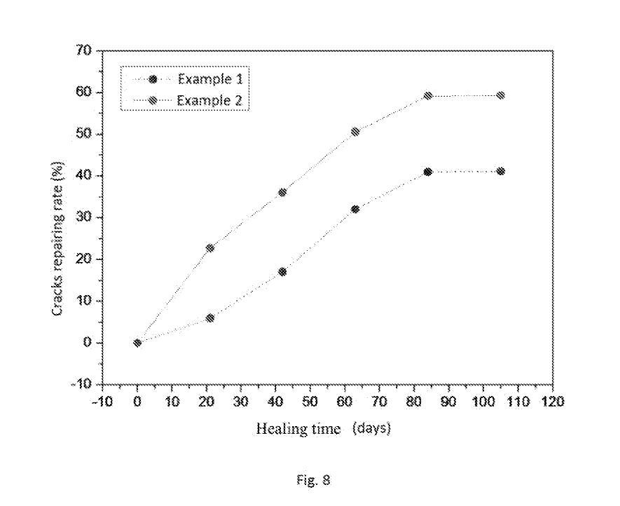

H. The cured concrete sample was preloaded with a load of 900 N to make cracks appear in its interior. X-ray computed tomography scanning technique (XCT) was employed to analyze and observe the development of the cracks and the effect of the cracks on the microcapsules, and to observe the microcapsules cracking to release the healing agent. Then, the sample was subjected to standard curing conditions (the relative humidity was above 95%, and the temperature was 21° C.) for curing. After 0 day, 21 days, 42 days, 63 days, 84 days and 105 days, the sample was scanned for analysis via XCT, and analyzed via 3D reconstruction and image processing to observe the healing of the cracks. FIG. 2 is a distribution diagram of the microcapsules in a cement-based material sample, and FIG. 4 is a 3D reconstruction diagram of the microcapsules in the cement-based material sample, in which the spheres in deep color are the microcapsules which can be integral with the concrete and have an uniform distribution. In FIG. 4, the spheres in light color are voids. As shown in FIG. 2, the spheres in light color are the microcapsules. FIG. 5-1, FIG. 5-2 and FIG. 5-3 show the variation of the same section of the self-healing concrete at the healing age of 0 day, 63 days and 105 days, respectively. As shown in FIG. 5-1, under the preload pressure, the cracks generating in the concrete made the microcapsules crack and the healing agent outflow. As the healing age increased, the healing agent flowed into the cracks slowly and reacted with free water to produce an expansion product to fill the cracks, as shown in FIGS. 5-2 and 5-3. Finally, the volume of the cracks inside the self-healing concrete in different periods was statistically analyzed by using the image processing technology to obtain the change in the volume rate of the cracks and the variation diagram of the cracks healing, as shown in FIGS. 7 and 8. As the healing age increased, the volume rate of the cracks inside the self-healing concrete decreased gradually. The volume rate of the cracks decreased from 1.1057% in the initial (0 day) to 0.651% (105 days from healing). The cracks healing rate increased with age, and reached 41.12% after 105 days of healing age.

### Example 2

Preparation of Polystyrene Encapsulated Sulphoaluminate Self-Healing Concrete

(1) Preparation of the Cores

TABLE 3
Amounts of raw materials for producing the cores
with sulphoaluminate cement as the healing agent (parts by weight)

| | Sulphoaluminate | Microcrystalline | | |
|---|---|---|---|---|
| No. | Cement | Cellulose | Tween 80 | 30% Ethanol |
| I | 100 | 90 | 8 | 100 |
| II | 100 | 90 | 10 | 110 |
| III | 100 | 95 | 9 | 110 |
| IV | 100 | 95 | 10 | 115 |
| V | 100 | 100 | 10 | 120 |

Wherein, 30% ethanol is an ethanol solution having an ethanol concentration of 30% by volume.

Raw materials for producing the cores were weighed according to the five formulas in Table 3, and then mixed. The mixture was fed into an extrusion device for extrusion, and a rice noodle shaped core material was then extruded. The rice noodle shaped core material was poured into a roll of a spheronizing device, and core particles were rolled out of the device. The core particles were dried at 30 to 40° C. under a force ventilation condition to obtain the cores.

(3) Preparation of the Microcapsules

TABLE 4
Amounts of raw materials for preparing the coating
liquid with trichloromethane as the solvent

| No. | Polystyrene | Trichloromethane |
|---|---|---|
| I | 100 | 900 |
| II | 100 | 1000 |
| III | 100 | 1200 |
| IV | 100 | 1400 |
| V | 100 | 1600 |

a. The raw materials were weighed according to the five formulas in Table 2, and the polystyrene was dissolved in the trichloromethane to prepare the coating liquid.

b. The coating liquid was atomized and then sprayed onto the cores obtained in said step (1). 1 to 2 g talcum powder was added every 5 to 10 minutes. These cores were dried at 30 to 40° C. for 10 to 20 minutes under a forced ventilation condition, then cooled naturally and dried naturally to obtain the microcapsules.

The produced microcapsules are spherical, and have a particle size of 200 to 500 μm and a wall thickness of 50 to 100 μm.

The produced microcapsules were placed under an electron microscope scanning apparatus for photographic analysis (as shown in FIG. 1) to observe whether the produced microcapsules met the requirements of the self-healing systems. According to FIG. 1, it can be seen that the produced microcapsules according to the present invention had good physical properties. Specifically, the produced microcapsules had a rough surface, an uniform particle size distribution, and a good shaping degree. These can cause better integral formation of the microcapsules and the concrete and an uniform distribution of the microcapsules.

The produced microcapsules were placed on a physical stress triggering device to study whether the produced microcapsules according to the present invention were able to crack under stress. As shown in FIG. 3, it can be seen that the microcapsules produced by the present invention were able to be triggered to crack under appropriate physical stress.

(3) Preparation of Polystyrene-Sulphoaluminate Self-Healing Concrete and Performance Testing Thereof

A. 1 kg cement, 1 kg sand, 0.4 g water, and 50 g microcapsules prepared in said step (2) were weighed;

B. The cement, sand and microcapsules weighed in said step A were added into a cement agitator and then stirred until they were uniformly dispersed to obtain a mixture;

C. The weighed water was poured into the mixture obtained in said step B, and then stirred uniformly;

D. The stirring process was performed slowly first and then faster;

E. After the concrete was vibrated, a workpiece was cast stepwise or step by step;

F. After a standing time of 1 to 2 hour, the mold was stripped, the overflow concrete slurry of the mold was struck off, and a secondary standing was performed for 24 hours;

G. The mold was removed, and the sample was placed into a standard curing chamber for concrete for curing for 28 days;

H. The cured concrete sample was preloaded with a load of 1100 N to make cracks appear in its interior. X-ray computed tomography scanning technique (XCT) was employed to analyze and observe the development of the cracks and the effect of the cracks on the microcapsules, and to observe the microcapsules cracking to release the healing agent. Then, the sample was subjected to standard curing conditions (the relative humidity was above 95%, and the temperature was 21° C.) for curing. After 0 day, 21 days, 42 days, 63 days, 84 days and 105 days, the sample was scanned for analysis via XCT, and analyzed via 3D reconstruction and image processing to observe the healing of the cracks. FIG. 2 is a distribution diagram of the microcapsules in a cement-based material sample, and FIG. 4 is a 3D reconstruction diagram of the microcapsules in the cement-based material sample, in which the spheres in deep color are the microcapsules which can be integral with the concrete and have an uniform distribution. As shown in FIG. 6, the spheres in light color are the microcapsules. FIG. 6-1, FIG. 6-2 and FIG. 6-3 show the variation of the same section of the self-healing concrete at the healing age of 0 day, 63 days and 105 days, respectively. As shown in FIG. 6-1, under the preload pressure, the cracks generating in the concrete made the microcapsules crack and the healing agent outflow. As the healing age increased, the healing agent flowed into the cracks slowly and reacted with free water to produce an expansion product to fill the cracks, as shown in FIGS. 6-2 and 6-3. Finally, the volume of the cracks inside the self-healing concrete in different periods was statistically analyzed by using the image processing technology to obtain the change in the volume rate of the cracks and the variation diagram of the cracks healing, as shown in FIGS. 7 and 8. As the healing age increased, the volume rate of the cracks inside the self-healing concrete decreased gradually. The volume rate of the cracks decreased from 2.2639% in the initial (0 day) to 0.9213% (105 days from healing). The cracks healing rate increased with age, and reached 59.30% after 105 days of healing age.

The above embodiments are only used to help understand the methodology and concept of the present invention. It should be noted that, for those skilled in the art, improvements and modifications may be made without departing from the principle of the present invention, and these improvements and modifications also fall within the scope of the present invention. Multiple amendments to these embodiments are obvious to those skilled in the art, and general principles defined in this application can be achieved in the other embodiments in case of not breaking away from the spirit or scope of the present invention. Thus, the present invention will be not limited to these embodiments shown in this application, but shall accord with the widest scope consistent with the principles and novel characteristics disclosed by this application.

1-15. (canceled)

16. A microcapsule for self-healing concrete, comprising:
a core and a wall, wherein components of the core comprise a healing agent, microcrystalline cellulose and Tween 80, and a material of the wall is a high-molecular organic material sensitive to stress of cracks.

17. The microcapsule of claim 16, wherein the core is prepared by the following steps comprising:
weighing raw materials for producing the core according to the following parts by weight:
healing agent 100;
microcrystalline cellulose 90 to 100;
Tween 80 8 to 10;
30% ethanol 100 to 120;
wherein, said 30% ethanol is an ethanol solution having an ethanol concentration of 30% by volume;
extruding a mixture: mixing the raw materials in said weighing step 1701 and feeding them into an extrusion device to obtain a rice noodle shaped core material;
spheronizing the core material, pouring the rice noodle shaped core material into a roll of a spheronizing device to obtain core particles; and
drying the core particles under a forced ventilation condition, with a drying temperature of 30 to 40° C.

18. The microcapsule of claim 16, wherein the microcapsule is prepared comprising the following steps:
preparing a coating liquid weighing 100 parts by weight of the high-molecular organic material sensitive to stress of cracks and 900 to 1600 parts by weight of a solvent, and dissolving the high-molecular organic material in the solvent to obtain the coating liquid;
spraying the coating liquid: placing the cores into a roll of a spray coating device, spraying the coating liquid obtained in said preparing a coating liquid step onto the rolling cores by a spray nozzle of this device using a pump in a coating mode; and adding 1 to 2 g talcum powder every 5 to 10 minutes to obtain cores with coating; and
drying the cores with coating obtained in said spraying step under a forced ventilation condition, and then performing a temperature decreasing naturally and drying naturally process to obtain the microcapsules, with a drying temperature of 30 to 40° C., a drying time of 10 to 20 minutes, and the drying process carried out in a roll of a drying device.

19. The microcapsule of claim 18, wherein the solvent is a mixture of ethanol and toluene, or trichlorotoluene.

20. The microcapsule of claim 19, wherein a weight ratio of ethanol to toluene in the mixture of ethanol and toluene is 150 to 300 and 800 to 1000.

21. The microcapsule of claim 18, wherein the high-molecular organic material sensitive to stress of cracks is polyacrylic acid resin, polystyrene or ethyl cellulose.

22. The microcapsule of claim 21, wherein, in said preparing a coating liquid step, 100 parts by weight of ethyl cellulose, 150 to 300 parts by weight of ethanol, and 800 to 1000 parts by weight of toluene are used to prepare the coating liquid, and the ethyl cellulose is dissolved in the mixture of ethanol and toluene.

23. The microcapsule of claim 21, wherein, in said step 1801, 100 parts by weight of polystyrene, and 900 to 1600 parts by weight of trichloromethane are used to prepare the coating liquid, and the polystyrene is dissolved in the trichloromethane.

24. The microcapsule of claim 16, wherein the microcapsule is spherical and has a particle size of 200 to 500 μm, and a thickness of the wall is 50 to 200 μm.

25. The microcapsule of claim 16, wherein the healing agent is sulphoaluminate cement.

26. The microcapsule of claim 16, wherein the components of the core further comprise a curing healing material.

27. The microcapsule of claim 26, wherein the curing healing material is an epoxy resin or a curing agent.

28. A method for preparing the microcapsule, comprising steps of:
preparing cores, mixing the healing agent, microcrystalline cellulose, Tween 80 and 30% ethanol and feeding the mixture into an extrusion device through a feeding port thereof to obtain a rice noodle shaped core material by extrusion;
pouring the rice noodle shaped core material into a roll of a spheronizing device to obtain core particles; and feeding the core particles into a roll of a drying device and performing a drying process under a forced ventilation condition with a drying temperature of 30 to 40° C.;
preparing a coating liquid, weighing 100 parts by weight of the high-molecular organic material sensitive to stress of cracks and 900 to 1600 parts by weight of a solvent, and dissolving the high-molecular organic material in the solvent to obtain the coating liquid;
spraying the coating liquid: placing the cores obtained in said preparing cores step into a roll of a spray coating device, spraying the coating liquid obtained in said step preparing a coating liquid onto the rolling cores by a spray nozzle of this device using a pump in a coating mode; and adding 1 to 2 g talcum powder every 5 to 10 minutes to obtain cores with coating; and
drying the cores with coating obtained in said spraying step under a forced ventilation condition, and then performing a temperature decreasing naturally and drying naturally process to obtain the microcapsules, with a drying temperature of 30 to 40° C., a drying time of 10 to 20 minutes, and the drying process carried out in a roll of a drying device.

29. A self-healing concrete, comprising:
cement, sand, water, and microcapsules with a core and a wall, wherein components of the core comprise a healing agent, microcrystalline cellulose and Tween 80, and a material of the wall is a high-molecular organic material sensitive to stress of cracks, with each cubic meter of the concrete containing 0.05 to 0.08 cubic meter of the microcapsules.

30. A method for preparing the self-healing concrete of claim 29, comprising steps of:
weighing appropriate amounts of cement, sand, water and microcapsules and microcapsules with a core and a wall, wherein components of the core comprise a healing agent, microcrystalline cellulose and Tween 80, and a material of the wall is a high-molecular organic material sensitive to stress of cracks, with each cubic meter of concrete containing 0.05 to 0.08 cubic meter of the microcapsules;
stirring the cement, sand and microcapsules weighed in said weighing step until uniformly dispersed to obtain a mixture; and
pouring the water into the mixture obtained in said stirring step, stirring them to be uniform to obtain the self-healing concrete.
